(19) United States
(12) Patent Application Publication
(10) Pub. No.: US 2013/0329944 A1
(43) Pub. Date: Dec. 12, 2013

(54) TRACKING AIRCRAFT IN A TAXI AREA

(71) Applicants: Mahesh Kumar Gellaboina, Kurnool (IN); Gurumurthy Swaminathan, Bangalore (IN); Saad J. Bedros, West St. Paul, MN (US); Vit Libal, Praha (CZ)

(72) Inventors: Mahesh Kumar Gellaboina, Kurnool (IN); Gurumurthy Swaminathan, Bangalore (IN); Saad J. Bedros, West St. Paul, MN (US); Vit Libal, Praha (CZ)

(73) Assignee: HONEYWELL INTERNATIONAL INC., Morristown, NJ (US)

(21) Appl. No.: 13/494,625

(22) Filed: Jun. 12, 2012

(51) Int. Cl. G01S 13/58; G06K 9/46

(52) U.S. Cl. 382/103; 342/36

(57) ABSTRACT

Tracking aircraft in a taxi area is described herein. One method includes receiving a video image of an aircraft while the aircraft is taxiing, determining a portion of the video image associated with the aircraft, determining a geographical track associated with the aircraft based, at least in part, on the portion of the video image, and mapping the determined geographical track to a coordinate system display while the aircraft is taxiing.

### TECHNICAL FIELD

The present disclosure relates to tracking aircraft in a taxi area.

### BACKGROUND

Airports can have a number of aircraft (e.g., airplanes) on taxi areas (e.g., on taxiway(s) tarmac(s) and/or apron(s)). Such aircraft can be moving (e.g., taxiing) and/or stationary (e.g., parked, idling, shut down, etc.). Airport personnel (e.g., operators, managers, air traffic controllers, etc.) may desire to manage aircraft movement on taxi areas.

Previous approaches for managing aircraft movement on taxi areas may include the use of predefined traffic rules (e.g., labels and/or surface signs). Such approaches may be ineffective to increase safety (e.g., collision avoidance), security (e.g., zone intrusion detection) and/or traffic efficiency (e.g., usage and/or throughput) within taxi areas, for instance.

Previous approaches may include the use of radar to track aircraft on taxi areas. Occlusions (e.g., stationary aircraft) may create radar blind zones and/or inhibit constant aircraft tracking under previous approaches.

### BRIEF DESCRIPTION OF THE DRAWINGS

FIG. 1A illustrates a calibration image of a taxi area acquired by an imaging device in accordance with one or more embodiments of the present disclosure.

FIG. 1B illustrates an overhead view of a taxi area in accordance with one or more embodiments of the present disclosure.

FIG. 2 illustrates a system for tracking aircraft in a taxi area in accordance with one or more embodiments of the present disclosure.

FIG. 3 illustrates a method for tracking aircraft in a taxi area in accordance with one or more embodiments of the present disclosure.

### DETAILED DESCRIPTION

Tracking aircraft in a taxi area is described herein. For example, embodiments include receiving a video image of an aircraft while the aircraft is taxiing, determining a portion of the video image associated with the aircraft, determining a geographical track associated with the aircraft based, at least in part, on the portion of the video image, and mapping the determined geographical track to a coordinate system display while the aircraft is taxiing.

Embodiments of the present disclosure can monitor taxi areas using a number of imaging devices (e.g., video cameras). Accordingly, embodiments of the present disclosure can increase safety, security, and/or traffic efficiency of airport taxi areas (e.g., taxiways, tarmacs, and/or aprons). Additionally, embodiments of the present disclosure can be used to augment radar tracking of aircraft on taxi areas with existing imaging devices installed at an airport.

Further, embodiments of the present disclosure can use multiple imaging devices to reduce (e.g., minimize and/or eliminate) blind zones in taxi areas. Additionally, embodiments of the present disclosure can allow real-time (e.g., immediate) display of tracked aircraft location (e.g., coordinates) on a Geographic Information System (GIS) rendering (e.g., orthomap, orthophoto, and/or orthoimage).

In the following detailed description, reference is made to the accompanying drawings that form a part hereof. The drawings show by way of illustration how one or more embodiments of the disclosure may be practiced. These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

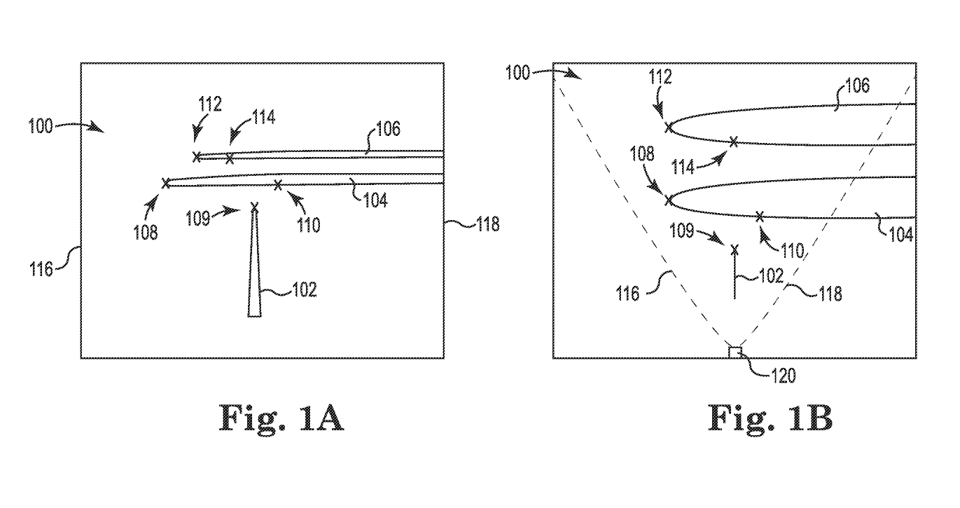

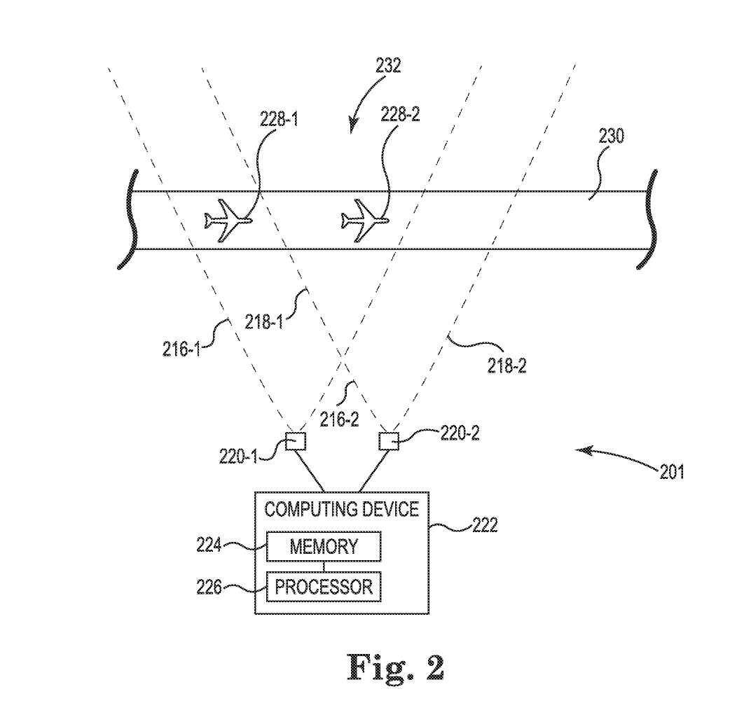

The figures herein follow a numbering convention in which the first digit or digits correspond to the drawing figure number and the remaining digits identify an element or component in the drawing. Similar elements or components between different figures may be identified by the use of similar digits. For example, 116 may reference element “16” in FIG. 1, and a similar element may be referenced as 216 in FIG. 2. As used herein, “a” or “a number of” something can refer to one or more such things. For example, “a number of tracks” can refer to one or more tracks.

FIG. 1A illustrates a calibration image (e.g., side view) of a taxi area 100 acquired by an imaging device (e.g., imaging device 120 discussed below in connection with FIG. 1B). FIG. 1B illustrates an overhead view (e.g., analogous to a GIS rendering) of taxi area 100. As shown in FIGS. 1A and 1B, imaging device 120 can capture images (e.g., video images) within a field of view defined on either side by viewing boundaries 116 and 118.

Embodiments of the present disclosure do not limit GIS renderings, as used herein, to aerial views (e.g., fly-over and/or satellite images). For example, GIS renderings can include graphical depictions and/or renderings created, edited, and/or enhanced by users and/or computing devices. Additionally, embodiments of the present disclosure do not limit taxi areas, as used herein, to a particular type and/or shape. For example, taxi areas can include areas upon which an aircraft can move and/or taxi. Such areas can include taxiways tarmacs and/or aprons, for instance, among others.

As illustrated in FIG. 1, taxi area 100 includes a surface line (e.g., painted stripe) 102 and taxiway dividers (e.g., grass medians) 104 and 106. Taxiway dividers 104 and 106 can define taxiways and/or areas of an apron, for instance. A number of landmarks 108, 109, 110, 112, and 114 can be selected (e.g., assigned) on the ground plane of the calibration image (illustrated as FIG. 1A). Although five landmarks (108-114) are shown, embodiments of the present disclosure do not limit the selection of landmarks to a particular number of landmarks.

Once selected, the locations of landmarks 108-114 in the calibration image (illustrated as FIG. 1A) can each be correlated (e.g., via homography) with the respective locations of the landmarks 108-114 in the GIS rendering (illustrated as FIG. 1B). Locations can be expressed using, and/or mapped to, a coordinate system (e.g., latitude and longitude, x,y, and/or other systems). Such geographical locations in the coordinate system can be referred to as geopoints, for instance.

Once a calibration image is obtained and location(s) of landmark(s) are correlated from the calibration image to the GIS rendering, imaging device 120 can be used to capture (e.g., obtain, acquire, photograph, videotape) images of aircraft on taxi area 100.

FIG. 2 illustrates a system 201 for tracking aircraft in a taxi area in accordance with one or more embodiments of the present disclosure. As shown in FIG. 2, system 201 can include a computing device 222. Computing device 222 can be communicatively coupled to a first imaging device 220-1 and/or a second imaging device 220-2. A communicative coupling can include wired and/or wireless connections and/or networks such that data can be transferred in any direction between first imaging device 220-1, second imaging device 220-2, and/or computing device 222.

Although one computing device is shown, embodiments of the present disclosure are not limited to a particular number of computing devices. Additionally, although two imaging devices are shown, embodiments of the present disclosure are not limited to a particular number of imaging devices. Imaging devices 220-1 and/or 220-2 can, for example, be analogous to imaging device 120, previously discussed in connection with FIGS. 1A and/or 1B.

Computing device 222 includes a processor 226 and a memory 224. As shown in FIG. 2, memory 224 can be coupled to processor 226. Memory 224 can be volatile or nonvolatile memory. Memory 224 can also be removable (e.g., portable) memory, or non-removable (e.g., internal) memory. For example, memory 224 can be random access memory (RAM) (e.g., dynamic random access memory (DRAM), and/or phase change random access memory (PCRAM)), read-only memory (ROM) (e.g., electrically erasable programmable read-only memory (EEPROM), and/or compact-disk read-only memory (CD-ROM)), flash memory, a laser disk, a digital versatile disk (DVD), and/or other optical disk storage), and/or a magnetic medium such as magnetic cassettes, tapes, or disks, among other types of memory.

Further, although memory 224 is illustrated as being located in computing device 222, embodiments of the present disclosure are not so limited. For example, memory 224 can also be located internal to another computing resource, e.g., enabling computer readable instructions to be downloaded over the Internet or another wired or wireless connection.

Memory 224 can store executable instructions, such as, for example, computer readable instructions (e.g., software), for tracking aircraft in taxi areas in accordance with one or more embodiments of the present disclosure. For example, memory 224 can store executable instructions for receiving a video image of an aircraft while the aircraft is taxiing. Additionally, memory 107 can store, for example, the received video images, among other data items.

Processor 226 can execute the executable instructions stored in memory 224 to track aircraft in a taxi area in accordance with one or more embodiments of the present disclosure. For example, processor 226 can execute the executable instructions stored in memory 224 to determine a geographical track associated with the aircraft based, at least in part, on the video image.

As illustrated in FIG. 2, imaging devices 220-1 and/or 220-2 can visualize (e.g., capture video images of) a taxi area (e.g., taxiway 230). First imaging device 220-1 is illustrated in FIG. 2 as having a field of view defined by viewing boundaries 216-1 and 218-1. Second imaging device 220-2 is illustrated in FIG. 2 as having a field of view defined by viewing boundaries 216-2 and 218-2. As illustrated in FIG. 2, an overlapping area 232 of taxiway 230 can be visualized by first imaging device 220-1 and second imaging device 220-2 simultaneously. As illustrated in FIG. 2, imaging device 220-1 and imaging device 220-2 are located in different positions. Such positions can be selected to increase (e.g., maximize) video coverage of a taxi area, for instance.

Additionally and/or alternatively, position(s) of imaging devices 220-1 and/or 220-2 can be fixed. That is, a position and/or orientation of imaging devices 220-1 and/or 220-2 can be held stable such that calibration images (previously discussed) may be captured from a same position as images of aircraft (e.g., aircraft 228-1 and/or 228-2, discussed below), for instance.

Imaging device 220-1 and/or imaging device 220-2 can be motion activated, for instance. Additionally and/or alternatively, imaging device 220-1 and/or imaging device 220-2 can be equipped with tracking functionality (e.g., motion tracking) such that an object can be tracked as it moves through field(s) of view defined by viewing boundaries 216-1 and 218-1, and/or 216-2 and 218-2. Tracking can include acquiring and/or capturing images over a number of frames (e.g., over time). Further, tracking can include determining a location (e.g., an (x, y) position) within the image(s), acquired and/or captured using imaging devices 220-1 and/or 220-2, of an object (e.g., aircraft 228-1 and/or 228-2).

Computing device 222 can receive a video image captured by first imaging device 220-1 and/or second imaging device 220-2. For example, computing device 222 can receive a video image of aircraft 228-1 on taxiway 230. In a manner analogous to the correlation of the locations in the landmarks 108-114 in the calibration image with the respective locations of the landmarks 108-114 in the GIS rendering (previously discussed), a video image, captured by imaging device 220-1, of aircraft 228-1 can be correlated with a geographical location in a GIS rendering.

A portion of the video image associated with aircraft 228-1 (e.g., the location of the aircraft in the video image) can be determined based on motion (e.g., motion tracking by first imaging device 220-1 and/or second imaging device 220-2). Accordingly, the location (e.g., track) of aircraft 228-1 can be mapped to a set of geographical coordinates and/or displayed on a GIS rendering (e.g., as a number of geopoints). Further, a shape of aircraft 228-1 can be determined using, for example, motion detection functionality of first imaging device 220-1 and/or second imaging device 220-2. A determined shape can be displayed by a particular configuration of geopoints, for instance.

Mapping the location of aircraft can include mapping a determined center (e.g., bottom center) and/or centroid of the aircraft. Mapping the location of aircraft can include mapping the aircraft as a whole using a bottom portion of the detected aircraft in the video image, for instance. Computing device 222 can display the aircraft in the GIS rendering as an icon, for example, though embodiments of the present disclosure do not limit the display of aircraft to a particular shape, size, and/or depiction.

Mapping the location of the aircraft can include mapping based on known landmarks (e.g., locations of barriers and/or geographic features) associated with the taxi area. For example, taxiway dividers 104 and/or 106 can be areas between taxiways. Computing device 222 can use locations of such dividers to map location of aircraft because, for example, aircraft may not be likely to be taxiing on and/or across taxiway dividers 104 and/or 106.

Mapping the location of the aircraft can include mapping based on a determined speed of the aircraft. Such a determined speed can be used in a Kalman filter parallel data fusion framework (discussed below) to predict locations of aircraft at particular times, for instance.

Additionally and/or alternatively, mapping the location of the aircraft can include mapping based on a determined direction of travel associated with the aircraft. Such a determined direction can be used to predict locations of aircraft at particular times, for instance.

As previously discussed, a number of images of an aircraft can be captured by a number of imaging devices simultaneously. For example, aircraft 228-2 is illustrated in FIG. 2 as being located within overlapping area 232. Accordingly, aircraft 228-2 is within the field of view for both imaging device 221-1 and 220-2.

Accordingly, if an aircraft (e.g., aircraft 228-2) is viewed by more than one imaging device (e.g., by imaging devices 221-1 and 220-2) a number of (e.g., two) video images can be correlated with (e.g., mapped to) a number of geographic locations and/or tracks in a GIS rendering. In such a scenario, computing device 222 can use a fusion-based algorithm to determine (e.g., compute and/or estimate) a fused geographical location (e.g., track) of aircraft 228-2 on the GIS rendering. For example, computing device 222 can use a Kalman filter parallel data fusion framework to fuse the aircraft location information from a number of imaging devices and/or track the aircraft location coordinates (e.g., movement) in the GIS rendering.

For example, computing device 222 can initiate a Kalman filter for each track in the GIS rendering (e.g., a GIS coordinate system) and once each track is initiated, computing device 222 can predict a future position of the track using the Kalman framework. A Kalman filter framework can be considered to have two equations: a measurement equation and a state equation.

Using the measurement equation,

z(t)=H*x(t)+v,

wherein an observation vector (z) can be a linear function of a state vector (x). The linear relationship between (z) and (x) can be represented by pre-multiplication by an observation matrix (H). Computing device 222 can consider (v) to be measurement noise and can additionally make an assumption that (v) can be Gaussian. Computing device 222 can define a geographical location (x(t)) of a track in a GIS rendering by (x, y). (z(t) can represent information associated with a tracked object (e.g., aircraft 228-2) in the video image(s). Information associated with a tracked object can include metadata (e.g., tracking information), for instance.

In an example, four imaging devices can be used to obtain respective images of an aircraft moving in a taxi area. Accordingly, a state vector can be defined as:

x(t)=(X,Y),

and an observation vector can be defined as:

z(t)=[x1;y1;x2;y2;x3;y3;x4;y4],

wherein the location of the aircraft on the ground from the first imaging device to the fourth imaging device can be defined as:

(x1,y1)−(x4,y4).

Accordingly, the observation matrix can be defined as:

H=[10;01;10;01;10;01;10;01].

Because computing device 222 can determine eight measurements, measurement noise covariance can be an 8×8 matrix, defined as:

R=noise variance*eye(8,8).

Continuing in the example, the state equation can be:

x(t+1)=A*x(t)+w,

wherein computing device 222 can alter the state vector, x, during one time step by pre-multiplying by the state transition matrix, A. The state transition matrix can be affected by a noise parameter, w, which computing device 222 can assume to be Gaussian.

Computing device 222 can initialize a tracked location for each GIS-rendered aircraft. Additionally, computing device 222 can receive multiple images having multiple locations of a single aircraft (e.g., while the aircraft is moving). Once computing device 222 correlates the locations of the aircraft in the received video images with respective geographical locations (e.g. geopoints) in a GIS rendering, computing device 222 can cluster (e.g., using Kmeans clustering) locations in the rendering to form groups such that each group can be assigned to a track (e.g., a GIS rendering of an aircraft). Computing device 222 can determine the mean of the group and assign the mean as an initial value of a new track (e.g., another GIS rendering of an aircraft).

Additionally, computing device 222 can continue tracking an aircraft after a track has been initiated. For example, computing device 222 can determine the geographical location (e.g., track) of aircraft 228-2 in a GIS rendering and can determine whether the geographical location is within a threshold distance of a prior determined geographical location (e.g., prior track) of the aircraft. Accordingly, computing device 222 can use a predicted Kalman location of the prior track to determine a present geographical location of aircraft 228-2, for instance.

For example, in an example using four imaging devices, (x1c1,y1c1), (x2c1,y2c1), and (x3c1,y3c1) can represent respective geographical locations of three different aircraft visualized by a first imaging device. Computing device 222 can identify a geographical location of the aircraft within a threshold distance of a prior determined geographical location of the aircraft based on video images and/or video image information received from the first imaging device. Such a location can be defined as (x1,y1).

In an analogous manner, for example, computing device 222 can identify geographical locations of the aircraft within a threshold distance of prior respective geographical locations of the aircraft based on video images and/or video image information received from a second, third, and/or fourth imaging device (e.g., (x2,y2), (x3,y3), and/or (x4,y4), respectively). Computing device 222 can repeat this process for each aircraft in the taxi area (e.g., for each track in the GIS rendering). Additionally and/or alternatively, computing device 222 can assign a coordinate (e.g., (0,0)) in an instance where no determined track is within the threshold distance from the prior determined track.

Continuing in the example, subsequent to determining four geopoints from the four imaging devices within the threshold distance(s), computing device 222 can update the determined track of the aircraft using the Kalman filter framework. Computing device 222 can use the Kalman filter framework to fuse the inputs from multiple imaging devices and/or can provide an estimation of the track at various points in time.

In addition and/or alternative to using the Kalman filter framework to fuse multiple determined locations and predict locations, computing device 222 can use various heuristics to reduce (e.g., minimize) errors associated with determining locations and/or tracks of aircraft. For example, if computing device 222 has assigned geopoints to respective tracks, remaining geopoints (e.g., geopoints not assigned to a track) can be processed in various ways by computing device 222.

For example, if a particular geopoint is determined based on a video image received from a first imaging device, and if computing device has already determined a track based on a number of other geopoints determined based on the video image received from the first imaging device, computing device 222 can associate the particular geopoint with that track. Additionally and/or alternatively, if a number of determined geopoints have been associated with each other (e.g., clustered) before they were assigned to an existing track, computing device 222 can associate those geopoints to the existing track.

Additionally and/or alternatively, computing device 222 can selectively delete a number of tracks and/or geopoints. For example, subsequent to assigning determined locations, based on video images received from respective imaging devices, to existing tracks, computing device 222 can delete a track if, for example, a number of frames without measurement of the track exceeds a threshold. Further, computing device 222 can delete a track if, for example, a number of frames the aircraft remains stationary exceeds a threshold.

Computing device 222 can augment determined locations and/or tracks of aircraft based on video images received from imaging devices with additional information. For example, such additional information can include information associated with aircraft tail detection using a number of appearance and/or shape-based algorithms. Computing device 222 can receive video images from imaging devices (e.g., imaging devices 120, 220-1 and/or 220-2, previously discussed in connection with FIGS. 1A, 1B, and or 2) of aircraft (e.g., aircraft at position 228-1) and determine (e.g., recognize and/or detect) a tail portion of the aircraft.

Additionally and/or alternatively, computing device 222 can augment determined locations with information communicated from various aircraft. Such information can include, for example, information communicated by an Automatic Identification System (AIS) and/or transponder. Such information can additionally be displayed in a GIS rendering such as those previously discussed. For example, a received signal from a transponder of an aircraft can be associated with a mapped geographical track corresponding to the same aircraft.

Additionally and/or alternatively, computing device 222 can augment determined locations with information received from various sensing devices. Determined locations of aircraft can be augmented with information acquired by pressure sensors on taxi areas, for instance. Such information can be communicated to computing device and used to determine aircraft locations and/or track aircraft in a taxi area.

As previously discussed, embodiments of the present disclosure can be used to augment radar location data (e.g., data received from a radar system) associated with tracking aircraft. Accordingly, computing device 222 can receive radar location data and use the radar location data in tracking aircraft in a taxi area.

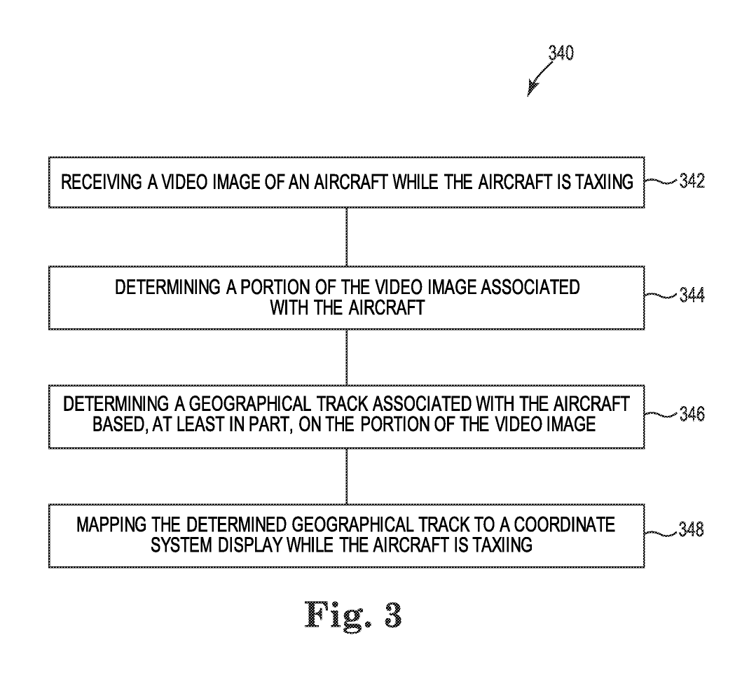

FIG. 3 illustrates a method 340 for tracking aircraft in a taxi area in accordance with one or more embodiments of the present disclosure. Method 340 can be performed by computing device 222, discussed above in connection with FIG. 2, for example.

At block 342, method 340 includes receiving a video image of an aircraft while the aircraft is taxiing. A video image can be received in a manner analogous to that previously discussed in connection with FIGS. 1A, 1B, and/or 2.

At block 344, method 340 includes determining a portion of the video image associated with the aircraft. A portion of the video image associated with the aircraft can be determined (e.g., using motion detection) in a manner analogous to that previously discussed in connection with FIG. 2, for example.

At block 346, method 340 includes determining a geographical track associated with the aircraft based, at least in part, on the portion of the video image. A geographical track can be determined in a manner analogous to that previously discussed in connection with FIG. 2.

At block 348, method 340 includes mapping the determined geographical track to a coordinate system display while the aircraft is taxiing. The determined geographical track can be mapped to a coordinate system in a manner analogous to that previously discussed in connection with FIGS. 1A, 1B, and/or 2.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for tracking aircraft in a taxi area, comprising:
receiving a video image of an aircraft while the aircraft is taxiing;
determining a portion of the video image associated with the aircraft;
determining a geographical track associated with the aircraft based, at least in part, on the portion of the video image; and
mapping the determined geographical track to a coordinate system display while the aircraft is taxiing.

2. The method of claim 1, wherein the method includes:
detecting a motion associated with the portion of the video image; and
determining a shape of the aircraft based on the detected motion.

3. The method of claim 1, wherein the method includes:
receiving a plurality of video images of the aircraft while the aircraft is taxiing;
determining a respective portion of each video image associated with the aircraft;
detecting a respective motion associated with each of the respective portions; and
determining the geographical track associated with the aircraft, based, at least in part, on the detected motions.

4. The method of claim 1, wherein the method includes determining a geographical track associated with the aircraft based, at least in part, on a geographical location of a barrier associated with the taxi area.

5. The method of claim 1, wherein the method includes:
receiving data from a pressure sensing device; and
determining a geographical track associated with the aircraft based, at least in part, on the video image and the data from the pressure sensing device.

6. The method of claim 1, wherein the method includes:
identifying a tail portion of the aircraft from the video image; and
determining the geographical track associated with the aircraft based, at least in part, on a shape of the tail portion.

7. The method of claim 1, wherein the method includes:
receiving radar location data associated with the aircraft; and
determining a geographical track associated with the aircraft based, at least in part, on the video image and the radar location data.

8. The method of claim 1, wherein the method includes associating a received signal from a transponder of the aircraft with the mapped geographical track.

9. The method of claim 1, wherein the method includes displaying the aircraft in a graphical rendering as an icon.

10. A system for tracking aircraft in a taxi area, comprising:
a plurality of video imaging devices configured to capture a plurality of at least partially overlapping video images including an aircraft while the aircraft is taxiing; and
a computing device configured to:
determine a respective geographical track associated with the aircraft based on each of the plurality of video images; and
determine a fused geographical track associated with the aircraft based, at least in part, on the respective geographical tracks.

11. The system of claim 10, wherein the computing device is configured to:
determine a speed of the aircraft while the aircraft is taxiing, and
determine the fused geographical track based, at least in part, on the determined speed of the aircraft.

12. The system of claim 10, wherein the computing device is configured to:
determine a direction of travel associated with the aircraft while the aircraft is taxiing; and
determine the fused geographical track based, at least in part, on the determined direction of travel.

13. The system of claim 10, wherein each of the plurality of video imaging devices are positioned at a different respective location.

14. The system of claim 10, wherein each of the plurality of video imaging devices is positioned such that a video image of a particular portion of the taxi area is captured by at least one video imaging device.

15. The system of claim 10, wherein the computing device is configured to determine the fused geographical track using a Kalman filter parallel data fusion framework.

16. The system of claim 10, wherein the computing device is configured to determine the fused geographical track based on a clustering associated with the respective geographical tracks.

17. The system of claim 10, wherein the computing device is configured to:
determine a first geographic location associated with the aircraft based on a first video image;
determine a second geographical location associated with the aircraft based on a second video image; and
associate the first and second determined geographical locations with the fused geographical track.

18. A computing device for tracking aircraft in a taxi area, comprising:
a memory; and
a processor configured to execute instructions stored on the memory to:
receive a calibration image of a portion of a taxi area from a video imaging device, wherein the portion includes a number of landmarks;
correlate a location of each of the landmarks in the calibration image with a respective geographical location of each of the landmarks in a geographical coordinate system;
receive an image of an aircraft from the video imaging device as the aircraft moves through the portion; and
determine a position of the aircraft in the geographical coordinate system based, at least in part, on the correlation and the image of the aircraft.

19. The computing device of claim 18, wherein the video imaging device is configured to capture the image of the aircraft from a same geographical position as the calibration image.

20. The computing device of claim 18, wherein the processor is configured to execute instructions to:
receive another calibration image of the portion of the taxi area from another video imaging device, wherein the portion includes the number of landmarks;
correlate a location of each of the landmarks in the other calibration image with a respective geographical location of each of the landmarks in the geographical coordinate system;
receive another image of the aircraft from the other video imaging device as the aircraft moves through the portion; and
determine a fused position of the aircraft in the geographical coordinate system based, at least in part, on the correlations and the images of the aircraft.
